(19) United States
(12) Patent Application Publication
(10) Pub. No.: US 2005/0218093 A1
(43) Pub. Date: Oct. 6, 2005

(54) Rack for holding packs of plastic bags

(76) Inventor: Rafael A. Alvarado, Houston, TX (US)

Correspondence Address: G. Alan Witte;Frost Bank Building, Suite 920, 6750 West Loop South, Houston, TX, 77401, US

(21) Appl. No.: 10/814,469

(22) Filed: Mar. 31, 2004

(51) Int. Cl. B42F 1/00

(52) U.S. Cl. 211/59.1

(57) ABSTRACT

A rack for hanging four packs of different sized plastic bags of the type having an upper disposable portion and a lower bag portion.

### BACKGROUND OF THE INVENTION

1. Field of the Invention

The present invention relates to a rack for holding four packs of different sized plastic bags of the type having an upper disposable portion and a lower bag portion.

2. Description of the Related Art

In supermarkets and other retail outlets, there is frequently the need for consumers or store employees to place items in bags to facilitate handling and purchase. For example, produce bags are dispensed directly to customers wherein the customer can bag produce as it is chosen for purchase. Also, in deli or meat departments, store employees place meats and other deli products in bags for the consumer. Further, in bakery departments, store employees place the selected bakery products in bags for the consumer. In the prior art, there are a number of designs for dispensing bags for these purposes.

Roll mounted produce bags are commonly found in modern grocery stores and supermarkets. These bags are designed for customers to use when purchasing fresh produce. The bags currently available are difficult for customers to use for several reasons. First, the bags tend to cling together and are difficult to separate from the roll. Second, is difficult to tell the open end of the bags from the closed end of the bag. Third, the bags are difficult to open as the sides tend to cling together. Fourth, all of the bags are of the same size, limiting the user's ability to choose different sized bags.

U.S. Pat. No. 5,732,833, commonly owned by applicant, discloses a dispensing assembly for supporting packs of plastic bags. The packs of plastic bags include a disposable upper portion connected to a lower bag portion. This patent shows dispensing assemblies for supporting two and three packs of plastic bags. With these dispensing assemblies, if packs of different sized plastic bags were hung on the dispensing assemblies, the visual presentation would be disorganized and would not be acceptable.

Thus, there are a number of shortcomings with the known rolls of plastic bags and packs of plastic bags. A common problem with bag dispensing systems is providing different sized bags to the user in a visually appealing fashion.

### SUMMARY OF THE INVENTION

Accordingly, a need has arisen for a rack for holding four packs of different sizes of plastic bags.

In accordance with present invention, a rack is provided for holding four packs of different sized plastic bags, comprising: a rectangular platform having four sides, each side having at least one hook for hanging at least one pack of plastic bags, a base, and at least one vertical member connecting the platform and the base, wherein the platform comprises a horizontally orientated sheet, wherein each of the four packs of different sized plastic bags comprises a plurality of individual bag units joined together, wherein the hooks are V-shaped.

Accordingly, an object of the present invention is to provide a rack for holding packs of different sized plastic bags in a visually appealing manner.

### BRIEF DEDSCRIPTION OF THE DRAWINGS

A better understanding of the invention can be obtained when the detailed description of exemplary embodiments set forth below is considered in conjunction with the attached drawings in which:

FIG. 1 is a perspective view of an embodiment of the present invention.

FIG. 2 is a front view of a pack of plastic bags having a header with tabs for attaching the pack to at least one support hook.

FIG. 3 is a front view of a pack of plastic bags having a header with holes through the header for attaching the pack to at least one support hook.

FIG. 4 is a magnified view of a hook on the upper surface of a platform.

### DETAILED DECRIPTION OF THE EXEMPLARY EMBODIMENTS

The present invention relates to a rack for holding four packs of different sized plastic bags. While the racks and packs of plastic bags may be used for any purpose, the preferred use of the racks and packs of plastic bags is at a bakery counter. With the preferred use, a consumer selects a bakery good and the bakery store employee selects a bag size from the four packs of different sized plastic bags and places the bakery goods in the bag, removes and seals the bag, and provides the bag with the bakery products to the customer.

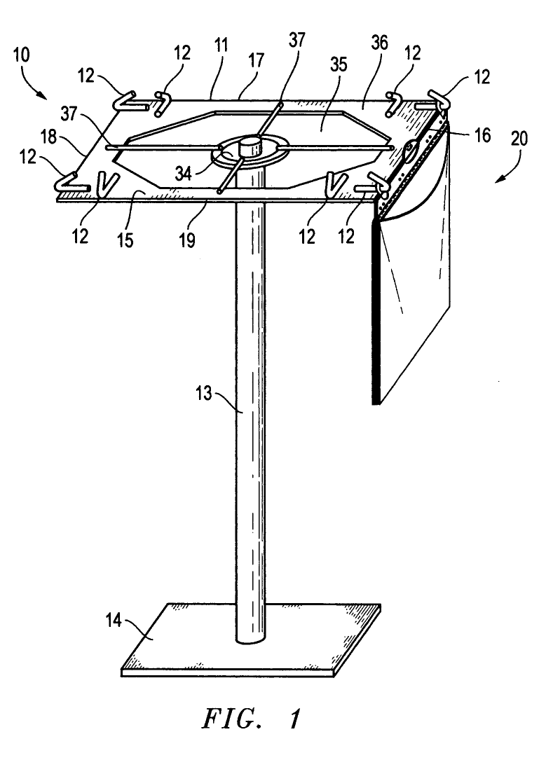

With reference to FIG. 1, a rack 10 (also referred to as a bag dispensing assembly) is shown having a platform 11, a plurality of hooks 12, at least one vertical member 13, and a base 14. The platform 11 has an upper surface 15, a first side 16, a second side 17, a third side 18, and the fourth side 19. The hooks 12 are attached to the upper surface 15 of the platform 11 at each of the four sides 16, 17, 18 and 19. A pack of plastic bags 20 is shown hanging on the hooks 12 on side 16.

The platform 11 is preferably rectangular shaped, formed from a sheet of material, and oriented in a horizontal manner on the vertical member 13. While the platform 11 may be formed in any suitable way, preferably, the platform 11 has a central member 34 which allows rotation about the vertical member 13. As shown, the central member 34 is cup shaped and fits on top of the vertical member 13 with the top portion of the vertical member 13 fitting within the cup shaped central member 34 and the diameter of the vertical member 13 below the platform 11 being greater than the diameter of the cup shaped central member 34 such that the central member 34 sits on and rotates about the vertical member 13. Also, preferably, the platform 11 has a central opening section 35, an outer plate area 36 and rods 37 which connect the central member 34 with the outer plate area 36. The central opening section 35 serves to reduce the weight of platform 11 to help prevent a tip over and the damage or injury to occur if the device 10 were to tip over. The central opening section 35 also serves to present the packs of plastic bags in visually appealing manner and to aid the user in seeing the packs of different sized plastic bags 20 such that he may choose an appropriately sized plastic bag.

The hooks 12 are generally constructed from a rod or thick wire bent into a V shape. As shown in FIG. 4, the hooks 12 have a first leg 32 for attaching to the upper surface 15 of the platform 11 and a second leg 33 projecting an angle of about 45 degrees to the platform 11. It has been found that hooks 12 having this V shape along with the placement on the top surface 15 of the platform 11 serves to at least partially obscure the platform 11 from view, presenting the packs of plastic bags 20 in a more visually appealing way. Preferably, the hooks 12 extend beyond the end of the platform 11. Preferably, a pair of hooks 12 is spaced 8 inches apart.

The rack 10 is designed to stand on the floor. The vertical member 13 is preferably a rod or leg which supports the platform 11 in an elevated position, preferably at about the waist of the user. While preferably the vertical member 13 is one rod or leg, it is possible that multiple vertical members 13 could be used, for example, four vertical members 13 could support the platform 11. While the vertical member 13 is shown as a round tubular member, it can also be made in other shapes, for example, from square tubular material. The base 14 may be any suitable base for holding the rack 10 in an upright position. While the base 14 is shown as a flat plate, it is to be understood that the various other types of bases could be used and are contemplated as being within the scope of the present invention.

The rack 10 may be constructed of any suitable materials including, for example, stainless steel, plastic, or acrylic. Additionally, different parts of the rack 10 may be constructed of different materials, for example, the platform 11 may be constructed of stainless steel while the vertical member 13 is constructed of plastic.

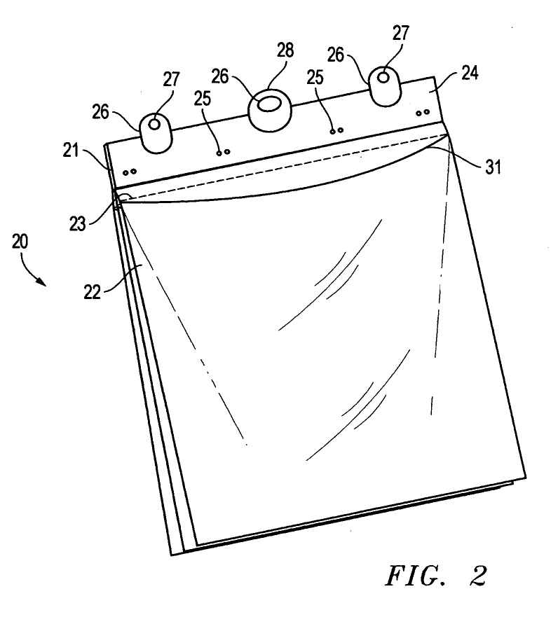

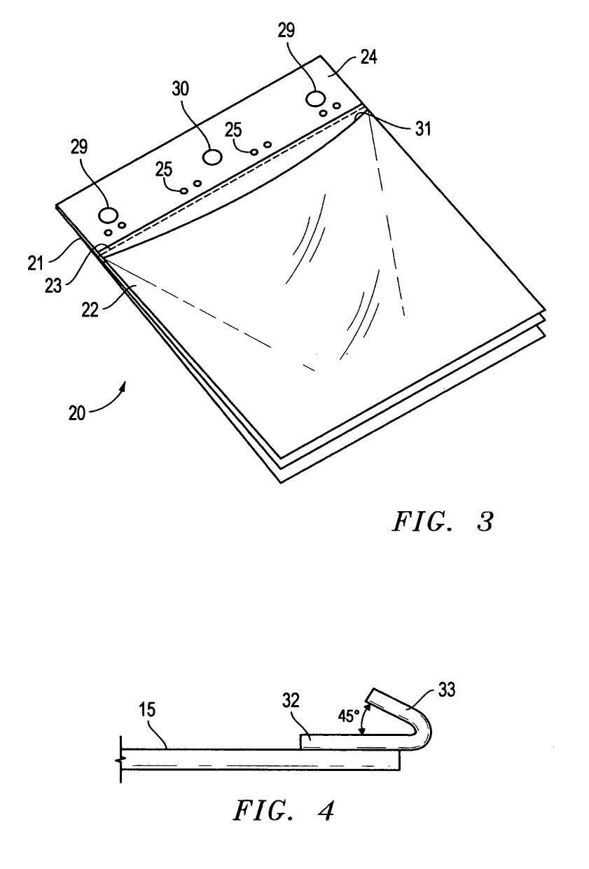

FIG. 1, 2 and 3 show packs of bags 20 wherein a number of individual bag units are joined together to form the pack 20. The individual bag units have a disposable upper portion 21 and a lower bag portion 22 with a seration 23 between the disposable upper portion 21 and the lower bag portion 22. In forming the pack 20, the individual bag units are stacked on top of each other, and a header 24 is placed about the disposable upper portion 21. The header 24 and the disposable upper portions 21 are joined together in any suitable way; preferably, the header 24 is joined to the disposable upper portions 21 by inserting heated blunt rods through the header 24 and the disposable upper portions 21 to melt the header 24 and the disposable upper portions 21 together about the points of insertion 25. The insertion of the heated blunt rods serve to melt the plastic immediately adjacent to the header 24 and the disposable upper portions 21 at the points of insertion 25 to join together the header 24 and the disposable upper portions 21 of the individual bag units. In FIG. 2 and 3, the points of insertion 25 show that small circular heated blunt rods were used to melt the plastic in the header 24 and the disposable upper portions 21; however, any shape of blunt heated rods would be suitable for this purpose. The header 24 is formed by cutting a flat, generally rectangular plastic piece and folding the rectangular plastic piece longitudinally in half to substantially cover the disposable upper portions 21.

FIG. 2 shows one embodiment of the header 24 wherein tabs 26 are cut from the header 24 (prior to folding the header 24 in half) and side holes 27 and center whole 28 are placed in the tabs 26. FIG. 3 shows another embodiment of the header 24 having side holes 29 and center hole 30. Here, the holes 29, 30 may be cut out of the header 24 and the disposable upper portions 21, or the holes 29, 30 may be formed with the use of heated to blunt rods as discussed above and as is known in the art. Preferably, the side holes 27, 29 are designed to be 8 inches apart. The side holes 27, 29 are utilized when two support hooks 12 are used; the center holes 28, 30 are utilized when one support hook 12 is used.

Alternatively, a pack of plastic bags 20 may be formed without a header 24. In this embodiment (not shown), the individual bag units are stacked on top of each other and the disposable upper portions 21 are joined together such as by inserting heated blunt rods through the disposable upper portions 21 to melt the disposable upper portions 21 together about the points of insertion. The holes for hanging on a rack may be cut out of the disposable upper portions 21 or formed with the use of heated blunt rods.

The individual bag units generally include a back sheet and a front sheet which are sealed around the sides and bottom to form the lower bag portions 22. The back sheet includes seration 23 and the disposable upper portions 21, while the front sheet terminates just below seration 23 to form a bag opening 31. The individual bag units formed with opening 31 allows a product to be placed in a bag while the bag remains attached to the pack of plastic bags 20 such that the user may then use two hands to remove the bag from the pack of plastic bags 20 and seal the bag.

The material use to create the plastic bags may be any suitable plastic resin, including: low density polyethylene; linear low density polyethylene; high-density polyethylene; high molecular weight, high-density polyethylene; and polypropylene. The plastic film used to create the plastic bags may be either a single extruded layer or multiple, coextruded layers.

The present invention provides a rack 10 which is floor standing, stable, requires a minimal amount of space and is inexpensive to fabricate. It presents packs of different sized plastic bags in a neat and orderly, visually appealing manner. With the present invention, it is convenient to select the appropriate sized bag, and the rack 10 is easy to stock with packs of plastic bags.

An inventive feature of the present invention is that the rack 10 having four sets of hooks 12 allows the placement of four packs of different sized plastic bags 20 in a neat and orderly manner such that the user may select which sized bag is appropriate for the product being placed in the bag. With known racks for holding packs of plastic bags, if different sized plastic bags were hung on the racks, the packs of plastic bags would be presented in a sloppy or haphazard manner. A rectangular platform 11 having four sets of hooks 12 provides a more visually appealing way to present four packs of different sized plastic bags 20 than any other known way for presenting multiple packs of plastic bags 20. Here, it is preferable to hang wider packs of plastic bags on the wider sides of the rectangular platform 11, here shown as sides 17 and 19. Also, as discussed above, preferably the platform 11 rotates about the vertical member 13 allowing the user to more easily select the appropriate sized bag.

In the bakery section of a grocery store it is advantageous to have several packs of plastic bags of different sizes, for example, long thin bags for holding French bread, and wider, shorter bags for holding muffins. The present invention provides for the presenting of four packs of different sized plastic bags allowing the user to select the appropriate sized bag for the product being placed in a bag.

The present inventive rack is advantageous over known racks for holding packs of plastic bags in that it provides a neat and orderly, visually pleasing presentation of four packs of different sized plastic bags.

All patents referred to herein are hereby incorporated by reference in their entireties.

Having described the invention above, various modifications of the techniques, procedures, materials, and equipment will be apparent to those skilled in the art. It is intended that all such variations within the scope and spirit of the invention be included within the scope of the appended claims.

1. A rack for holding four packs of different sized plastic bags, comprising:
a rectangular platform having four sides, each side having at least one hook for hanging at least one pack of plastic bags,
a base, and
at least one vertical member connecting the platform and the base,
wherein the platform comprises a horizontally orientated sheet,
wherein each of the four packs of different sized plastic bags hang on the at least one hook on the side of the rectangular platform and comprise a plurality of individual bag units joined together,
wherein the hooks are V-shaped.

2. The rack of claim 1, wherein each hook is attached to an upper surface of the rectangular platform.

3. The rack of claim 2, wherein each hook has a first leg connected to the upper surface and a second leg projecting at an angle of about 45 degrees to the upper surface.

4. The rack of claim 3, wherein the first leg extends beyond the platform.

5. The rack of claim 1, wherein each side of the platform has 2 hooks.

6. The rack of claim 5, wherein the hooks on each side of the platform are spaced about 8 inches apart.

7. The rack of claim 1, wherein the platform rotates about the at least one vertical member.

8. The rack of claim 1, wherein each individual bag unit has an upwardly facing opening.

9. The rack of claim 1, wherein each individual bag unit is comprised of a front sheet and a back sheet, wherein the back sheet includes a disposable upper portion and a seration and the front sheet terminates just below the seration to form a lower bag portion.

10. The rack of claim 1, wherein the platform has a central open section.

11. A plastic bag dispensing assembly for dispensing plastic bags from four packs of different sized plastic bags, comprising:
a horizontal platform having an upper surface and four sides, each side having at least one hook for hanging at least one pack of plastic bags,
a base,
at least one vertical member connecting the platform and the base,
wherein the hooks are attached to the upper surface of the platform,
wherein the hooks are constructed of a rod bent into a V-shape, the hooks having a first leg for attaching to the platform and a second leg projecting at an angle of about 45 degrees to the platform.

12. The plastic bag dispensing assembly of claim 11, wherein the four packs of different sized plastic bags hang on the hooks on each side of the horizontal platform.

13. The rack of claim 11, wherein the first leg extends beyond the platform.

14. The rack of claim 11, wherein each side of the platform has 2 hooks.

15. The rack of claim 14, wherein the hooks on each side of the platform are spaced about 8 inches apart.

16. The rack of claim 11, wherein the platform rotates about the at least one vertical member.

17. The rack of claim 11, wherein the platform has a central open section.
